(19) United States
(12) Patent Application Publication
(10) Pub. No.: US 2009/0223136 A1
(43) Pub. Date: Sep. 10, 2009

(54) Polishing compound for semiconductor wafer polishing and polishing method

(75) Inventors: Masaru Nakajo, Koto-ku (JP); Masahiro Izumi, Koto-ku (JP); Shinsuke Miyabe, Koto-ku (JP); Kuniaki Maejima, Koto-ku (JP); Hiroaki Tanaka, Ayase-shi (JP)

Correspondence Address: H. JAY SPIEGEL - H. JAY SPIEGEL & ASSOCIATES, P.O. BOX 11, MOUNT VERNON, VA, 22121, US

(73) Assignees: Nippon Chemical Industrial Co., Ltd. (50%); Speedfam Co., Ltd. (50%)

(21) Appl. No.: 12/230,353

(22) Filed: Aug. 28, 2008

(30) Foreign Application Priority Data
Aug. 29, 2007 (JP) JP2007-222518

(51) Int. Cl. C09K 3/14

(52) U.S. Cl. 51/308; 51/307

(57) ABSTRACT

The polishing compound for semiconductor wafer of the present invention contains colloidal silica composed of silica particles to which tetraethylammonium is fixed, and concentration of silica particles dispersed in water is between 0.5 to 50 weight %. Concentration of tetraethylammonium contained in silica particles to which tetraethylammonium is fixed is desirable to be in the range from 5×10⁻⁴ to 2.5×10⁻² as indicated by molar ratio of tetraethylammonium/silica.

### FIELD OF THE INVENTION

The present invention relates to a polishing compound that polishes the surface or edge part of a semiconductor wafer such as silicon wafer or semiconductor device substrate on the surface of which metal film, oxide film or nitride film (hereinafter shortened to metal films) is formed. Further, the present invention relates to a method for polishing of the surface or edge part of a semiconductor wafer using this polishing compound.

### DESCRIPTION OF THE PRIOR ART

Regarding a polishing compound that polishes the surface or edge part of a semiconductor wafer such as silicon wafer or semiconductor device substrate on the surface of which metal films is formed, many kinds of compounds are proposed. As a polishing compound that is mainly composed of silica abrasives, solution containing alkaline component is popular, and the theory for polishing can be explained as follows. That is, chemical action by alkaline component, specifically, erosive action of alkaline component to the surface of silicon oxide film or metal films, and mechanical polishing action by silica abrasives are used together. Thus by erosive action of alkaline component a thin and soft eroded layer is formed on the surface of a workpiece (object to be processed) such as wafer. And, it is presumed that said eroded layer is removed by mechanical polishing action of fine particles of abrasive, and by repeating this process, polishing is progressed. After polishing process of the workpiece, washing process is carried out so that to remove silica abrasives or alkaline solution from the polished surface or edge part of the workpiece.

At this washing process, remain of abrasive particles on the surface of wafer is pointed out as a problem, and it is considered that alkali metal, especially sodium, takes part to the mechanism of remain of abrasive particles. This problem can be improved largely by changing polishing condition or washing method, however, since these changes accompany remarkable deterioration of polishing rate or complication of washing method, these changes have not dissolve the problem.

Up to the present time, in case of mirror polishing of semiconductor wafer, a polishing compound that blends alkaline agents excepting alkali metal, especially sodium, is proposed. For example, in Patent Document 1, colloidal silica containing ethylenediamine is disclosed. In Patent Document 2, a polishing method for a device wafer that uses aqueous solution containing ethylenediamine, pyrocatechol, and fine particles of silica is disclosed. In Patent Document 3, a polishing compound prepared by dispersing fumed silica having average particle size of 5 to 30 nm in KOH aqueous solution and a method for preparation thereof are disclosed. In Patent Document 4, a polishing slurry containing colloidal silica from which sodium is removed by cation exchange is mentioned, and addition of amine as a polishing promoter and addition of quaternary ammonium salt as a bactericide are proposed. In Patent Document 6, high purified colloidal silica to be used for polishing which does not actually contain sodium is disclosed. Said colloidal silica is prepared by using tetramethylammonium hydroxide or choline hydroxide as an alkalizing agent to be used in growth process of colloidal silica instead of sodium hydroxide.

Many types of colloidal silica composed of non-spherical silica particles are proposed. In Patent Document 7, stable silica sol characterized that amorphous colloidal silica particles of long and slender shape having length of one plane with uniform thickness in range of 5 to 40 nm observed by an electron microscope which dispersed in liquid medium is mentioned. In Patent Document 8, silica sol composed of silica particle of long and slender shape obtainable by a method characterized by adding metal compounds such as aluminum salt before, in the middle or after an adding process of silicic acid solution is described. In Patent Document 9, a colloidal silica composed of cocoon shape silica particles whose ratio of long axis/short axis is from 1.4 to 2.2 prepared by hydrolysis of alkoxysilane is mentioned. In Patent Document 10, a method for preparation of colloidal silica containing non spherical silica particles by using hydrolysis solution of alkoxysilane instead of active silicic acid aqueous solution of water glass method and tetraalkylammonium hydroxide as an alkali is disclosed.

In the meanwhile, as a method for polishing, surface polishing method of semiconductor substrate by a double sided polishing machine mentioned in Patent Document 11 or by a single sided polishing machine can be mentioned. In Patent Documents 12 and 13, a polishing machine for edge of a disc shape workpiece and a method for polishing are proposed. In Patent Document 14, a circulation supplying method of polishing compound is disclosed.

Patent Document 1: JPA H2-146732 publication; claims

Patent Document 2: JPA H6-53313 publication; page 3

Patent Document 3: JPA H9-193004 publication; claims

Patent Document 4: JPA H3-202269 publication; claims, page 7

Patent Document 5: JPA 2002-105440 publication; page 2

Patent Document 6: JPA 2003-89786 publication

Patent Document 7: JPA H1-317115 publication; claims

Patent Document 8: JPA H4-187512 publication

Patent Document 9: JPA H11-60232 publication; claims

Patent Document 10: JPA 2001-48520 publication; claims and Example

Patent Document 11: JPA H11-302634 publication; page 2

Patent Document 12: JPA H3-208550 publication

Patent Document 13: JPA 2002-144201 publication

Patent Document 14: JPA 2003-297783 publication; page 2

### OBJECT OF THE INVENTION

In a case when ethylenediamine is used in a polishing compound as disclosed in Patent Documents 1 and 2, harmfulness of ethylenediamine is a problem. In Patent Document 3, KOH is used, however, when compared with NaOH, erosive power of KOH is slightly weak and improvement is also very small. Colloidal silica of lower sodium content mentioned in Patent Document 4, as described in page 7, polishing promoting agent is amine and quaternary ammonium salt is added by very small amount as a bactericide which has also polishing promotion effect. In Examples, use of aminoethylethanolamine and piperazine as an amine is mentioned. Recently, it becomes clear that amine is a cause of metal pollution of wafer, in particular, cupper pollution of wafer, because amine has a metal chelate forming function. Further, in same Document, KOH is used for the purpose of pH adjustment where reduction of sodium content is the main subject of this Document. In Patent Document 5, danger of wafer contamination by aminoethylethanolamine is described. Colloidal silica disclosed in Patent Document 6 is very good polishing compound, because sodium is not existing in water phase, on surface of particles or inside of particles. However, when compared with NaOH or KOH, erosive action of tetramethylammonium hydroxide or choline hydroxide against to the surface of silicon oxide film or metal films is weak and polishing rate is low, and this is a defect of these compounds.

In a method for preparation of colloidal silica disclosed in Patent Document 7, there is a process to add water soluble potassium salt, magnesium salt or mixture thereof, and these salts are remaining in products as an impurity. In a method for preparation of colloidal silica disclosed in Patent Document 8, there is a process to add water soluble aluminum salt, and this salt is remaining in products as an impurity. Silica source of colloidal silica disclosed in Patent Documents 9 and 10 is alkoxysilane, and is desirable because of high purity of alkoxysilane, however, removal of by-product alcohol is difficult and is disadvantageous in price.

Regarding a polishing method, polishing methods which use a double sided polishing machine and a single sided polishing machine are widely used. Further, polishing methods using a polishing machine for outermost periphery of a semiconductor substrate disclosed in Patent Documents 12 and 13 are popular. In actual use of these polishing methods, circulation use of polishing compound is carried out for the purpose of cost reduction, and a circulation supplying method of polishing compound disclosed in Patent Document 14 or others are proposed. However, in cases to carry out polishing methods of Patent Documents 11 to 13 by circulation use of polishing compound, deionized water used in washing process of a workpiece after polishing process enters into and mixed with the polishing compound, accordingly dilutes the polishing compound. This phenomenon slows down the polishing rate. Therefore, controlling concentration of polishing compound using a circulation supplying method of polishing compound disclosed in Patent Documents 14 is required. However, in a case of polishing compound characterized that the change of polishing rate caused by concentration change of the polishing compound is large, it becomes necessary to set the control width of concentration of the polishing compound narrower, and is a problem because controlling is very difficult. Further, as mentioned above, for the purpose for higher productivity, development of a polishing compound having high polishing rate is desired. In general, a polishing compound having high polishing rate has a defect that the change of polishing rate caused by change of concentration of the polishing compound is large, and a polishing compound having both functions is strongly desired.

Therefore, the object of the present invention is to provide a polishing compound of lower alkali metal contents for semiconductor wafer polishing characterized to have high polishing rate and change of polishing rate according to change of concentration is small. And, another object of the present invention is to provide a method for polishing of semiconductor wafer using said polishing compound.

### BRIEF SUMMARY OF THE INVENTION

The inventors of the present invention have conducted eager study and have dissolved problems mentioned above.

The first invention is a polishing compound for semiconductor wafer comprising, colloidal silica composed of silica particles to which tetraethylammonium is fixed and concentration of said silica particles dispersed in water is between 0.5 to 50 weight %.

The second invention is a polishing compound for semiconductor wafer comprising, colloidal silica composed of silica particles inside of which tetraethylammonium is fixed and concentration of said silica particles dispersed in water is between 0.5 to 50 weight %.

And, the third invention is a polishing compound for semiconductor wafer comprising, colloidal silica composed of silica particles on the surface of which tetraethylammonium is fixed by coating a film mainly composed of silica containing tetraethylammonium, wherein, concentration of silica particles dispersed in water is between 0.5 to 50 weight %.

Hereinafter, both silica particles inside of which tetraethylammonium is fixed and silica particles on the surface of which tetraethylammonium is fixed by coating a film mainly composed of silica containing tetraethylammonium are mentioned as “silica particles to which tetraethylammonium is fixed.”

Further, this polishing compound for semiconductor wafer is desirable that the concentration of tetraethylammonium is in the range of from 5×10⁻⁴ to 2.5×10⁻² as indicated by molar ratio of tetraethylammonium/silica.

The fourth invention is the polishing compound for semiconductor wafer of said second or third inventions, wherein said polishing compound contains at least the one selected from the group consisting of tetraethylammonium hydroxide and tetramethylammonium hydroxide, and pH at 25° C. is from 8 to 11.

In the present invention, phrase of “containing tetraethylammonium hydroxide” indicates the state that said component exist by at least the one of the form selected from the group consisting of a state to be fixed on the surface of silica particles, a state to be fixed in inside of silica particles, and a state to be dissolved in water.

Further, it is desirable that said polishing compound for semiconductor wafer contains a buffer solution prepared by combination of weak acid and strong base whose logarithms of reciprocal number of acid dissociation constant (pKa) at 25° C. are from 8.0 to 12.5, and said the polishing compound for semiconductor wafer displays buffering action between pH of 8 to 11. It is further desirable that an anion composing the weak acid is at least the one selected from the group consisting of carbonate ion and hydrogencarbonate ion, and a cation composing the strong base is at least the one selected from the group consisting of choline ion, tetramethylammonium ion, and tetraethylammonium ion.

The fifth invention is the polishing compound for semiconductor wafer comprising, a mixture of the silica particles to which tetraethylammonium is fixed and spherical silica particles to which tetraethylammonium is not fixed, wherein concentration of the particles to which tetraethylammonium is fixed is from 0.5 to 10 weight % and total concentration of silica particles is from 0.5 to 50 weight %. It is desirable that the content of alkali metal to silica in said polishing compound for semiconductor wafer is less than 50 ppm.

Further, in said second invention, it is desirable to contain colloidal silica having average short axis of 5 to 30 nm measured by a transmission electric microscope and forming non spherical hetero particles cluster whose ratio of long axis/short axis is between 1.5 to 50 as the silica particles to which tetraethylammonium is fixed. In the present invention, the range indicated by wording of “ratio of long axis/short axis is between 1.5 to 15” contains narrower range within this range, for example, a case of long axis/short axis which is between 2 to 4 is included.

Further, in third invention, it is desirable that the polishing compound for semiconductor wafer contains colloidal silica whose average particle size is between 15 to 50 nm and is forming spherical particles cluster as the silica particles to which tetraethylammonium is fixed.

### BRIEF ILLUSTRATION OF DRAWINGS

FIG. 1: TEM observation picture of colloidal silica obtained in Preparation Example 1.

FIG. 2: Relationship between silica concentration and polishing rate at surface polishing.

FIG. 3: Relationship between silica concentration and polishing rate at edge polishing.

### DESCRIPTION OF PREFERRED EMBODIMENT

The present invention will be explained more in detail.

In the polishing compound for semiconductor wafer of the second invention, average of short axis of silica particles measured by electron micro scope observation is desirably between 5 to 30 nm and concentration of silica particle is between 0.5 to 50 weight %, and can be prepared by a method mentioned below. When average of short axis of silica particles is smaller than 5 nm, polishing rate is low, and particles can be easily flocculated and lacks stability of colloid. Further, when average of short axis of silica particles is larger than 50 nm, scratches are easily caused and flatness of a polished surface is deteriorated.

In the polishing compound for semiconductor wafer of the third invention, average particle size of silica particles composed of silica particles on the surface of which tetraethylammonium is fixed by coating a film mainly composed of silica containing tetraethylammonium measured by electron micro scope observation is desirably between 15 to 50 nm and concentration of silica is between 0.5 to 50 weight %, and can be prepared by a method mentioned below. When average axis of silica particles is smaller than 15 nm, polishing rate is low, and particles can be easily flocculated and lacks of stability of colloid. Further, when average of short axis of silica particles is larger than 50 nm, scratches are easily caused and flatness of a polished surface is deteriorated.

Colloidal silica composed of silica particles to which tetraethylammonium is fixed, is a colloidal silica obtained by using tetraethylammonium hydroxide as an alkalizing agent at the process to grow up particles of active silicic acid using an alkalizing agent. Accordingly, tetraethylammonium is existing by following three forms, that is, (1) a form that tetraethylammonium is fixed at inside of particles during the growing process of particles, (2) a form that tetraethylammonium is fixed on the surface of particles after the growing process of particles, and (3) a form that tetraethylammonium is dissolved in liquid phase. Tetraethylammonium in liquid phase exists as a tetraethylammonium ion, however, it is not clear whether the fixed tetraethylammonium is ionized or not.

In the meanwhile, when tetraethylammonium hydroxide is added to colloidal silica being on the market, effect of the present invention can not be obtained. That is, high polishing rate can not be accomplished only by making tetraethylammonium exist in liquid phase. Polishing mechanism of above mentioned case, namely, tetraethylammonium is existing only in liquid phase, is “by erosive action of alkaline component a thin and soft eroded layer is formed on the surface of a workpiece (object to be processed) such as wafer. And, it is presumed that said eroded layer is removed by mechanical polishing action of fine particles of abrasive, and by repeating this process, polishing is progressed,” however, in the case when tetraethylammonium exists by one of the three forms of the present invention, it is considered that function and effect, which can not be explained only by above mentioned mechanism, is caused. That is, polishing mechanism that fine abrasive particles, on the surface of which alkaline component is coordinated, abrade off the surface of workpiece should be presumed, and this mechanism is similar to the mechanism that ceria abrasives polish the surface of silicon wafer.

And, when tetraethylammonium is fixed in inside and on surface of silica particles, the fact that zeta potential of silica particles becomes slightly weak than original negative charge is confirmed, and this fact has an influence.

Colloidal silica composed of silica particles inside of which tetraethylammonium is fixed, which is used in second invention, can be prepared by a method mentioned below. That is, after active silicic acid aqueous solution is prepared by contacting silicic acid aqueous solution with cation exchange resin, tetraethylammonium hydroxide is added to obtained active silicic acid aqueous solution so as the solution to be alkaline, then a seed sol to be used as a nucleus is prepared by growing colloid particles with heating. Maintaining alkaline condition under heating, carry out build up of particles by adding active silicic acid aqueous solution and tetraethylammonium hydroxide, then colloidal silica is concentrated by carrying out ultrafiltration, thus aimed colloidal silica can be obtained.

Or, a method not using said build up procedure can be used. For example, a method to obtain particles larger than 10 nm at a stretch by heating liquid containing active silicic acid and tetraethylammonium hydroxide to the temperature higher than 120° C. using an autoclave, or a method to transform gel state silica to sol using a deflocculation method can be used.

Instead of the method for preparation of a seed sol, which is used as a nucleus, using tetraethylammonium hydroxide mentioned above, a method to use silica sol on the market as a seed sol can be mentioned. Further, mixed alkali composed of tetraethylammonium hydroxide and tetramethylammonium hydroxide can be also used. Furthermore, a method to prepare seed sol using tetramethylammonium hydroxide, then to use tetraethylammonium hydroxide only at particles build process can be used. Also, choline hydroxide can be used instead of tetramethylammonium hydroxide.

A method for preparation of colloidal silica whose component is afore mentioned silica particles to which tetraethylammonium is fixed, is almost same to the normal method for preparation that uses alkali metal hydroxide or silicic acid alkali as an alkalizing agent. That is, process to prepare an active sol from sodium silicate is same, and only a point to use tetraethylammonium hydroxide as an alkalizing agent at particles build process is different, further, a process to obtain a product by carrying out concentration is same.

When particles build process is carried out under afore mentioned specific condition using tetraethylammonium hydroxide, colloidal silica composed of silica particles to which tetraethylammonium is fixed and forming non spherical hetero particles cluster, which is desirably used in the second invention can be obtained. As mentioned below, colloidal silica to which tetraethylammonium is fixed to be used desirably in third invention.

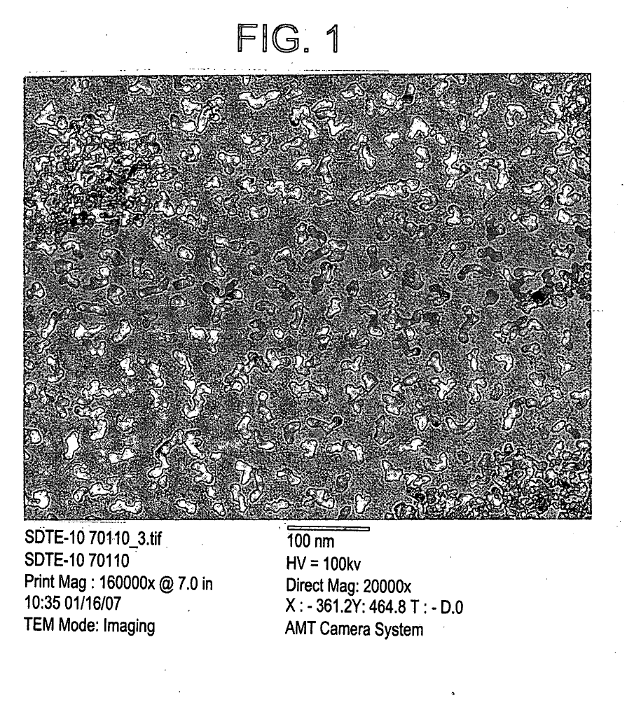

Colloidal silica forming non spherical hetero particles cluster is specifically a colloidal silica containing silica particles having a shape shown by FIG. 1 of Preparation Example 1 mentioned later, and is in the range of long axis/short axis ratio between 1.5 to 50. In the particles, particles not linearly extended occupy the most part, and partially not extended particles coexist. This is one example, and shape of particles differs variously according to preparation methods, and non-spherical particles occupy the most part.

Colloidal silica composed of silica particles on the surface of which tetraethylammonium is fixed by coating a film mainly composed of silica containing tetraethylammonium to be used in third invention can be obtained by using a spherical silica as a seed sol and by only using tetraethylammonium hydroxide for particles build up. This silica sol is a colloidal silica composed of spherical particles. Thickness of a film mainly composed of silica containing tetraethylammonium is desirably 1 to 10 nm. When the film is thinner than 1 nm, improvement of polishing feature is small, and the improvement of polishing feature is not sufficient when the thickness of film exceeds 10 nm. More desirable thickness is from 3 to 8 nm. This colloidal silica forms spherical particles cluster and it is desirable that the average particle size of silica particles measured by observation of an electronic microscope. When the average particle size is within said range, scratches will not cause at the actual polishing and good mirror polishing can be accomplished.

Above mentioned colloidal silica composed of silica particles on the surface of which tetraethylammonium is fixed by coating a film mainly composed of silica containing tetraethylammonium can be also obtained by using tetramethylammonium hydroxide together with tetraethylammonium hydroxide as an alkaline agent. Choline can be used instead of tetramethylammonium hydroxide.

The silica particles to which tetraethylammonium is fixed to be used in afore mentioned second and third inventions can reduce the contents of heavy metals in the preparation process. That is, active silicic acid aqueous solution is prepared by contacting silicic acid alkaline aqueous solution with cation exchange resin. After contacted this active silicic acid aqueous solution with chelate resin, a chelating agent or a both chelating agent and an oxidizing agent are added. Then, removing chelated metal impurity by carrying out ultrafiltration and by concentrating colloidal silica, refined colloidal silica can be obtained.

In a polishing process, shape of silica particles is an important factor. That is, surface of a workpiece is eroded by alkali and a thin layer is formed, and removal speed of the thin layer is changed largely according to the shape of silica particles. When particle size of silica particles is enlarged, polishing rate becomes fast, however, it becomes that scratches are easily formed on the polished surface. Therefore, it is desirable that the particles have adequate size and shape, and not easily to be crushed or not to be gelated by flocculation.

The silica particles of non-spherical hetero particles cluster to which tetraethylammonium is fixed, which can be desirably used in the second invention, is similar to silica particles of fumed silica. Generally, silica particles of fumed silica forms long and slender hetero particles cluster shape whose ratio of long axis/short axis is between 5 to 15. Primary particle size (sometimes, simply mentioned as particle size) of fumes silica indicates short axis (thickness) of primary particles and generally is between 7 to 40 nm and is not indicating the length of a long axis direction. Further, the particles are flocculated and forming a secondary particles and the appearance of slurry is white. Therefore, although polishing rate is high, scratches are easily caused. It also has a disadvantage that particles are settled when the slurry is left for long time.

On the contrary, silica particles to which tetraethylammonium is fixed to be used in the second invention have similar shape to that of primary particles of fumed silica. However, they do not form secondary particles by flocculation and the appearance of slurry is transparent or semi-transparent. The polishing compound using non-spherical silica particles to which tetraethylammonium is fixed, which can be preferably used in first invention, accomplishes higher polishing rate, does not cause scratches and can accomplish good mirror polishing compared with spherical silica particles.

And when compared with the polishing compound using non-spherical silica particles to which tetraethylammonium is fixed, which can be preferably used in second invention, the spherical particles cluster silica particles to which tetraethylammonium is fixed, which is preferably used in third invention, is slightly inferior in polishing rate. However, when compared with the conventional polishing compound characterizing that tetraethylammonium is existing in liquid phase alone, higher polishing rate can be accomplished even if the spherical particles cluster silica particles to which tetraethylammonium is fixed, and does not cause scratches and can accomplish good mirror polishing.

Meanwhile, in the present invention, silica particles to which tetraethylammonium is fixed to be used in second invention and silica particles to which tetraethylammonium is fixed to be used in third invention can be mixed by desired blending ratio and can be used as silica particles of the polishing compound for semiconductor wafer of the present invention.

In the polishing compound for semiconductor wafer of the present invention, concentration of afore mentioned silica particles to which tetraethylammonium is fixed to be used in second and third inventions are desirable to be 0.5 to 50 weight % to the total weight of solution. Concentration can be properly selected according to kinds of workpiece, that is, metal or silicon oxide, and cannot be restricted. For example, in a case of cupper alloy film, proper concentration of silica particles for polishing is between 0.5 to 2 weight %. Meanwhile, in the case of edge polishing, from the view point to improve polishing power of the polishing compound for semiconductor wafer more, it is desirable that the concentration of silica particles is between 2 to 25 weight %. In general, it is desirable to prepare a slurry of higher concentration than 30 weight % and dilute it for actual use. In a process of polishing plural wafers at same time by circulating slurry, the slurry can be easily diluted because deionized water mixes with the slurry. In this case, it is preferable to add high concentrated slurry properly to the slurry for the purpose to recover the concentration of diluted slurry.

Desirable concentration of tetraethylammonium contained in silica particles to which tetraethylammonium is fixed is within the range from 5×10⁻⁴ to 2.5×10⁻² by molar ratio of tetramethylammonium/silica. It is experimentally confirmed that tetraethylammonium hydroxide acts as an alkaline agent, further displays specific function to the polishing of semiconductor wafer. That is, it has a function to protect the remaining of abrasives on wafer surface. Therefore, it is desirable that tetraethylammonium hydroxide exists by range mentioned above.

And, the polishing compound for semiconductor wafer of the present invention is desirable to contain base (alkaline agent), and to maintain pH at 25° C. within 8 to 11. Further, in the present invention, it is desirable to maintain pH of the solution in the range of 8 to 11 for the purpose to keep stable polishing ability at polishing process. When pH is less than 8, polishing rate is deteriorated and sometimes becomes to be out of practical use. And, when pH is over 11, etching besides polishing part becomes too strong, and since silica particles become to have a tendency to flocculate, stability of polishing compound deteriorates and also becomes to be out of range of practical use. Further, it is desirable that the pH does not change easily by change of outer conditions such as friction, heat, contact with the air or mixing with other components. Especially, in a case of edge polishing, polishing compound is used by circulation. That is, polishing compound supplied to a polishing part from a slurry tank is returned to the slurry tank and reused. Conventional polishing compound that contains only alkaline agent, pH deteriorates in short time by circulation use. This is caused by dissolving of a workpiece or by mixing of washing water, and keeping of pH of polishing compound in the slurry tank at a certain level is very hard, and sometimes cause a problem of non polished point.

Therefore, in the present invention, it is desirable that the polishing compound for semiconductor wafer is a buffer solution, that is, pH change against outer condition change is small. For the formulation of buffer solution, combination use of weak acid and strong base whose logarithmic value of reciprocal number (pKa) of acid dissociate constant (Ka) at 25° C. is between 8.0 to 12.5 is preferable. The case that logarithmic value of reciprocal number of acid dissociate constant (pKa) is less than 8.0 is not desirable because it is necessary to add large amount of weak acid and strong base to elevate pH. And the case that logarithmic value of reciprocal number of acid dissociate constant (pKa) is larger than 12.5 is not desirable because it is difficult to form a buffer solution having large buffering function between range from pH 8 to 11.

In the present invention, as a weak acid to be used for the formation of the polishing compound for semiconductor wafer having buffer function, inorganic acids such as carbonic acid (pKa=6.35, 10.33), boric acid (pKa=9.24) or phosphoric acid (pKa=2.15, 7.20, 12.35), or water soluble organic acids can be mentioned, and mixture of these compounds can be also usable. As a water soluble organic acid, phenols such as phenol (pKa=10.0), catechol (pKa=9.25, 12.37) or hydroquinone (pKa=9.91, 11.56), amino acids such as glycine (pKa=2.35, 9.78), α-amino butyric acid (pKa=2.31, 9.66), aspartic acid (pKa=1.94, 3.70, 9.62), glutamic acid (pKa=2.30, 4.28, 9.67) or lysine (pKa=2.18, 9.18, 10.72) can be mentioned. By the way, carbonate acid includes a form of hydrogencarbonate ion. Further, as a strong base, it is desirable that a cation which composes the strong base is at least the one selected from the group consisting of choline ion, tetramethylammonium ion, tetraethyl ammonium ion or methyltrihydroxyethylammonium ion, more desirably is at least the one selected from the group consisting of tetramethylammonium ion or tetraethylammonium ion.

As a quaternary ammonium ion besides choline ion, tetramethylammonium ion, tetraethylammonium ion or methyltrihydroxyethylammonium ion, following ions, that is, benzyltrimethylammonium ion, tetrapropylammonium ion or phenyltrimethylammonium ion are desirable, because these ions can be purchased easily in the market.

Buffer solution recited in the present application is formed by above mentioned combination and indicates a state that a weak acid is dissociated in solution as an ion whose atomicity is different, or a solution in which dissociated state and undissociated state are coexisted, and the buffer solution is characterized that the change of pH is small even if small amount of acid or base are mixed.

In the present invention, polishing rate can be remarkably improved by elevating electric conductivity of polishing compound for semiconductor wafer. As a method to elevate the electric conductivity, following two methods can be mentioned. One is a method to elevate concentration of buffer solution and another one is a method to add salts. For the purpose to elevate concentration of a buffer solution, it is possible to elevate only concentration without changing molar ratio of acid and base. Salts used for the method to add salts are composed of combination of acid and base, and as an acid, both strong acid and weak acid can be used and mineral acid, organic acid or mixture of these acids also can be used. As a base, both strong base and weak acid can be used. It is desirable to use salts composed of strong acid and strong base. Chloride, sulfate or nitrate of water soluble quaternary ammonium is desirably used. For example, a salt such as tetramethylammonium nitrate is desirable. In cases to add by combination of weak acid and strong base, strong acid and weak base or weak acid and weak base, it is not desirable to add large amount, because pH of buffer solution is changed. It is possible to use these two methods together with.

The polishing compound for semiconductor wafer of the present invention, other silica particles can be contained within the limit that the total concentration of silica particles in colloidal solution is from 0.5 to 50 weight %. In this case, it is desirable that the concentration of silica particles to which tetraethylammonium is fixed is 0.5 to 10 weight %. As the other silica particles, silica particles that can be conventionally used for semiconductor polishing such as colloidal silica consisting of spherical silica particles to which tetraethylammonium is not fixed, not spherical shape colloidal silica such as string shape, cocoon shape or flat spherical shape colloidal silica or fumed silica can be mentioned. In particular, together use with spherical colloidal silica being on the market within the range that the content of alkali metal is not excessively large, is desirable.

Content of alkali metal in the polishing compound for semiconductor wafer of the present invention is desirably to be less than 50 ppm by alkali metal content to silica. To dissolve the problem of remaining of abrasive particles on the surface of wafer, it is desirable to make the content of alkali metal within said limit. More desirable limit of content of alkali metal is less than 30 ppm.

Namely, spherical silica to which tetraethylammonium is not fixed or fumed silica can be blended 1 to 10 weight parts by weight of silica to 1 part of silica particles to which tetraethylammonium is fixed. Desirably, spherical silica to which tetraethylammonium is not fixed can be blended 2 to 8 weight % by weight of silica to 1 part of silica particles to which tetraethylammonium is fixed.

Further, it is desirable that the polishing compound for semiconductor wafer of the present invention contains abrasive particles besides silica. As the abrasive particles besides silica, ceria, alumina, zirconia, organic abrasive or silica organic complex particles can be desirably used. And the desirable particle size of ceria, alumina or zirconia is 20 to 100 nm.

Furthermore, the polishing compound for semiconductor wafer of the present invention is desirable to contain a chelating agent except monoamine such as aminoethylethanolamine. As a chelating agent, which is used in the present invention, as far as it bonds as a multidentate ligand, any compounds can be used arbitrary in the limit not spoils the effect of the present invention. Polyamines or aminopolycarboxylic acids are desirably used, and for example, it is desirable to use the compound that is selected from the group consisting of (1) ethylenediaminetetraacetic acid and salts thereof, (2) hydroxyethylethylenediaminetriacetic acid and salts thereof, (3) dihydroxyethylethylenediaminediacetic acid and salts thereof, (4) diethylenetriamine-pentaacetic acid and salts thereof, (5) triethylenetetraminehexaacetic acid thereof, (6) hydroxyethyliminodiacetic acid and salts thereof, and (7) dihydroxyethylethylenediamine. Specifically, (1) diammonium ethylenediaminetetraacetate, triammonium ethylene diaminetetraacetate, and tetraammonium ethylenediaminetetraacetate (2) triammonium hydroxyethylethylenediaminetriacetate, (3) diammonium dihydroxyethylethylenediaminediacetate, (4) diethylenetriaminepentaacetic acid and tetraammonium diethylenetriaminetetraacetate, (5) hexaammonium triethylenetetraminehexaacetate, (6) diammonium hydroxyegthylimino diacetate, and (7) dihydroxyethylethylenediamine can be mentioned. Further, nitrilotriacetate, glycine or salicylic acid are desirable. Furthermore, gluconic acid and salts thereof, and gluconic acid-6-triammoniumphosphate are also desirable. Among these chelating agents, “acids” which does not contain alkali metal or “ammonium salts” are desirably used. These chelating agents can contain crystal water or can be anhydrides. Further, these chelating agents can be used together, and in cases of together use, blending ratio can be preferred voluntarily. The method to add a chelating agent and above mentioned oxidizing agent at same time can be used and is effective for removal of Cr.

Further, the polishing compound for semiconductor wafer of the present invention is desirable to contain a chelating agent which forms water insoluble chelate with cupper. For example, as a chelating agent, well known compounds such as azoles (e.g. benzotriazol), quinoline derivatives (e.g. quinolinol) or quinaldinic acid are desirable. Content of a chelating agent in the polishing compound for semiconductor wafer of the present invention differs by effect of chelating agent to be used, however, desirable range is between 0.01 to 1 weight %, or more desirably, between 0.05 to 0.5 weight % to total weight of the polishing compound for semiconductor wafer of the present invention. In general, there is a tendency that the effect of the present invention is improved by increasing adding amount of chelating agent. However, when the adding amount is excessively large, the effect of this invention becomes small, and sometimes causes economical demerit.

Furthermore, the polishing compound for semiconductor wafer of the present invention is also desirable to contain a surface-active agent. As a surface-active agent, any one of anionic surface-active agent, cationic surface-active agent, nonionic surface-active agent, amphoteric surface-active agent or polymer surface-active agent can be used, though it is desirable to contain a nonionic surface-active agent. A nonionic surface-active agent has an effect to prevent excess etching. As a nonionic surface-active agent, for example, polyoxyalkylenealkyl ether such as polyoxyethylenelaulyl ether, fatty acid ester such as glycerin ester, polyoxyalkylenealkyl amine such as di(polyoxyethylene)laulyl amine can be used, in particular, polyoxyalkylene alkyl ether is desirable. Proper concentration of a surface-active agent in the polishing compound for semiconductor wafer of the present invention is approximately between 1 to 1000 ppm.

Sometimes, a surface-active agent, in particular, an anionic surface-active agent has a tendency to cause a minus effect such as foaming. Generally, together use of a defoaming agent is preferable to control the foaming, and silicone defoaming agent is very effective. As a silicone defoaming agent, oil type, modified oil type, solution type, powder type or emulsion type can be mentioned, and among these, modified oil type and emulsion type are usable, because of high dispersing ability of modified oil type and emulsion type to a colloid solution, especially emulsion type displays best effect and has good durability. As a product in the market, for example, Shin-etsu silicone KM grade of Shin-etsu Chemical Industries Co., can be mentioned. Amount of use of a defoaming agent should be decided according to the amount of a surface-active detergent, however, proper concentration of a deforming agent in the polishing compound for semiconductor wafer of the present invention is approximately between 1 to 1000 ppm.

Still further, the polishing compound for semiconductor wafer of the present invention can improve the effect of it by blending water soluble polymer. As mentioned above, it is known that water soluble polymer whose molecular weight is larger than 5000 or whose molecular weight is larger than 100000 has a function to reduce metal contamination of wafer or to improve flatness of wafer, however, in a case to blend a polymer of such a high molecular weight, blending ratio is limited because higher blending amount causes a problem to elevate a viscosity of polishing solution. It is preferable to add water soluble polymer whose molecular weight is less than 5000, desirably is more than 500 and less than 3000 by 100 ppm to 10000 ppm to a polishing compound for semiconductor wafer.

As a water soluble polymer mentioned above, polyacrylic acid, polymetacrylic acid, polyvinyl pyrrolidone, polyvinyl alcohol, polyethylene glycol, maleic acid-vinyl copolymer, xanthan gum or cellulose derivatives can be used, however, at least the one selected from the group consisting of cellulose derivatives, polyvinyl alcohol and polyethylene glycol is desirable. As a cellulose derivatives, hydroxymethyl cellulose, hydroxyethyl cellulose, hydroxypropyl cellulose or carboxymethyl cellulose can be used, and among these compounds, hydroxyethyl cellulose is desirable. Polyethylene glycol whose molecular weight is 5000 or less than 5000 is more desirable.

Yet further, to the polishing compound for semiconductor wafer of the present invention, an oxidizing agent can be blended by voluntarily amount. As an oxidizing agent, hydrogen peroxide water, peroxosulfate or perborate are desirable.

For the purpose to improve the property of the polishing compound for semiconductor wafer of the present invention, fungicide, anti mold agent, pH indicator, humecant, water miscible organic solvent, anti freezing agent, rust preventive, polishing end point detective agent, coloring agent or anti precipitation agent can be blended properly. As a dispersing agent, or an anti precipitation agent, water soluble organic compound or inorganic lamellar compounds can be mentioned. And, although the polishing compound for semiconductor wafer of the present invention is aqueous solution, organic solvent can be added. Especially, ethyleneglycol or glycerin is desirable as an anti freezing agent or a humecant. Further, isopropylalcohol has an effect to reduce surface tension. At the preparation of the polishing compound for semiconductor wafer of the present invention, other abrasives such as colloidal silica, base, additives or water can be mixed.

### EXAMPLES

The present invention will be illustrated more in detail. Hereinafter, tetraethylammoniumhydroxide and tetramethylammoniumhydroxide can be shortened to TEAOH and TMAOH.

At the measurement in Examples, following equipments are used.

(1) TEM observation: Transmission Electron Microscope H-7500 of Hitachi, Ltd. is used.

(2) Specific surface area by BET method: Flow Sorb 2300 of Shimadzu Corporation is used.

(3) Ion chromatographic analysis of TEAOH and TMAOH: Ion Chromate ICS-1500 of Dionex Corporation is used. Specifically, in cases of liquid phase TEAOH and liquid phase TMAOH, specimen is diluted by 1000 to 5000 times with deionized water and measured. Further, in cases of total TEAOH and total TMAOH, as a previous treatment, 3 g of 20 weight % NaOH and deionized water are added to 5 g of specimen, heated to 80° C. and silica is perfectly dissolved. Obtained dissolved solution is diluted to 1000 to 5000 times with deionized water and total TEAOH amount and total TMAOH amount is measured.

(4) Analysis of total TEAOH and total TMAOH: Total organic carbon meter TOC-5000A, SSM-5000A of Shimadzu Corporation is used. Carbon amount is reduced to TEAOH and TMAOH, and measured numerical values obtained by the ion chromate analysis are confirmed. Specifically, total organic carbon amount (TOC) is calculated by numerical formula of TOC=TC−IC after total carbon amount (TC) and inorganic carbon amount (IC) are measured. As the standard for TC measurement, glucose aqueous solution of 1 weight % carbon amount is used, and as the standard for IC measurement, sodium carbonate of 1 weight % carbon amount is used. Ultrapure water is used as the standard of 0 weight % carbon amount and using above mentioned standards and calculation curves, 150 μL and 300 μL for TC and 250 μL for IC, are prepared. At TC measurement, 100 mg of specimen is picked and burned in a combustion furnace of 900° C. And at IC measurement, 20 mg of specimen is picked, 10 mL around of (1+1) phosphoric acid are added and reaction is accelerated in a combustion furnace of 200° C. Since analytical results of total TEAOH and total TMAOH by a carbon meter are met with that of by an ion chromate analysis, results by a carbon meter are abridged in following Examinations to clarify the description.

(5) Analysis of metal elements: ICP emission spectrometry ULTIMA 2 of Horiba, Ltd. is used.

Chemical reagents used in Examples are mentioned as follows.

(A) TEAOH: TEAOH aqueous solution of 20 weight % on the market (product of SACHEM Inc.)

(B) TMAOH: TMAOH aqueous solution of 25 weight % on the market. Hereinafter, can be shortened to TMAOH.

(C) Choline hydroxide: 48 weight % aqueous solution of choline on the market.

(D) Tetramethylammonium hydrogencarbonate: Carbon dioxide gas is blown into TMAOH aqueous solution of 25 weight % mentioned above and neutralized to pH 8.4. Results by chemical analysis indicates that the obtained solution is tetramethylammonium hydrogencarbonate of 33 weight %. Hereinafter, can be shortened to TMAHCO₃.

(E) Tetramethylammonium carbonate: TMAOH and tetramethylammonium hydrogencarbonate are mixed so as to meet the molar ratio prescribed in Examples. Hereinafter, can be shortened to (TMA)₂CO₃.

### Preparation Example 1

520 g of JIS 3 sodium silicate (SiO₂: 28.8 weight %, Na₂O: 9.7 weight %, H₂O: 61.5 weight %) is added to 2810 g of deionized water, mixed homogeneously and diluted sodium silicate of silica concentration 4.5 weight % is prepared. This diluted sodium silicate is passed through a column containing 1200 mL of H type strong acidic cation exchange resin (AMBERLITE IR120B, product of ORGANO CORPORATION), which is previously regenerated by hydrochloric acid and dealkalized, then 4040 g of active silicic acid characterized that silica concentration is 3.7 weight % and pH is 2.9 is obtained.

Then, colloidal particles are grown up by a build up method. That is, to 500 g of said obtained active silicic acid, 20 weight % TEAOH aqueous solution is added by stirring and pH is adjusted to 9, heated to 90° C. to boiling point and preserved for 1 hour, then remaining 3540 g of active silicic acid is added by 6 hours. During adding process, 20 weight % TEAOH aqueous solution is added so as to maintain pH to 10, and heating (90° C. to boiling point) is continued. After adding process is over, heating (90° C. to boiling point) is continued too, and is matured, then is cooled down. After that, pressure filtration by pump circulation using hollow fiber ultrafilter membrane is carried and concentrated to silica concentration 20 weight % and approximately 740 g of colloidal silica is recovered. Particle size measured by BET method of this colloidal silica is 10.9 nm, and according to a transmission electron microscope (TEM) observation, it is understood that the colloidal silica forms non spherical hetero particles cluster, wherein short axis is approximately 11 nm and ratio of long axis/short axis is between 1.5 to 15. Since total content of TEAOH is 1.57 weight % and liquid phase TEAOH is 0.87 weight %, TEAOH fixed on silica is calculated as 0.70 weight %. Molar ratio of fixed TEAOH/silica is 0.014. Further, Na content to silica is 15 ppm. By use of TEAOH, colloidal silica whose content of metal ion is small can be obtained. TEM observation of silica particles is shown in FIG. 1.

### Preparation Example 2

520 g of JIS 3 sodium silicate (SiO₂: 28.8 weight %, Na₂O: 9.7 weight %, H₂O: 61.5 weight %) is added to 2810 g of deionized water, mixed homogeneously and diluted sodium silicate of silica concentration 4.5 weight % is prepared. This diluted sodium silicate is passed through a column containing 1200 mL of H type strong acidic cation exchange resin (AMBERLITE IR120B, product of ORGANO CORPORATION), which is previously regenerated by hydrochloric acid and dealkalized, then 4040 g of active silicic acid characterized that silica concentration is 3.7 weight % and pH is 2.9 is obtained.

Then, colloidal particles are grown up by a build up method. That is, to 500 g of said obtained active silicic acid, equimolar mixture of 20 weight % TEAOH aqueous solution and 25 weight % TMAOH aqueous solution is added by stirring and pH is adjusted to 9, heated to 90° C. to boiling point and preserved for 1 hour, then remaining 3540 g of active silicic acid is added by 6 hours. During adding process, said equimolar mixture is added so as to maintain pH to 10, and heating (90° C. to boiling point) is continued. After adding process is over, heating (90° C. to boiling point) is continued too, and is matured, then is cooled down. After that, pressure filtration by pump circulation using hollow fiber ultrafilter membrane is carried and concentrated to silica concentration 20 weight % and approximately 740 g of colloidal silica is recovered. Particle size measured by BET method of this colloidal silica is 11.5 nm, and according to a transmission electron microscope (TEM) observation, it is understood that the colloidal silica forms non spherical hetero particles cluster, wherein short axis is approximately 12 nm and ratio of long axis/short axis is 1.5 to 10. Since total content of TEAOH is 0.89 weight % and liquid phase TEAOH is 0.32 weight %, TEAOH fixed on silica is calculated as 0.57 weight %. Molar ratio of fixed TEAOH/silica is 0.012. Further, Na content to silica is 15 ppm. By use of TEAOH, colloidal silica whose content of metal ion is small can be obtained.

### Preparation Example 3

520 g of JIS 3 sodium silicate (SiO₂: 28.8 weight %, Na₂O: 9.7 weight %, H₂O: 61.5 weight %) is added to 2810 g of deionized water, mixed homogeneously and diluted sodium silicate of silica concentration 4.5 weight % is prepared. This diluted sodium silicate is passed through a column containing 1200 mL of H type strong acidic cation exchange resin (AMBERLITE IR120B, product of ORGANO CORPORATION), which is previously regenerated by hydrochloric acid and dealkalized, then 4040 g of active silicic acid characterized that silica concentration is 3.7 weight % and pH is 2.9 is obtained.

Then, colloidal particles are grown up by a build up method. That is, to 500 g of said obtained active silicic acid, 25 weight % TMAOH aqueous solution is added by stirring and pH is adjusted to 9, heated to 90° C. to boiling point and preserved for 1 hour, then remaining 3540 g of active silicic acid is added by 6 hours. During adding process, 20 weight % TEAOH aqueous solution is added so as to maintain pH to 10, and heating (90° C. to boiling point) is continued. After adding process is over, heating (90° C. to boiling point) is continued too, and is matured, then is cooled down. After that, pressure filtration by pump circulation using hollow fiber ultrafilter membrane is carried and concentrated to silica concentration 30 weight %, and approximately 490 g of colloidal silica is recovered. Particle size measured by BET method of this colloidal silica is 13.0 nm, and according to a transmission electron microscope (TEM) observation, it is understood that the colloidal silica forms non spherical hetero particles cluster, wherein short axis is approximately 14 nm and ratio of long axis/short axis is 1.5 to 4.0. Since total content of TEAOH is 0.92 weight % and liquid phase TEAOH is 0.40 weight %, TEAOH fixed on silica is calculated as 0.52 weight %. Molar ratio of fixed TEAOH/silica is 0.007. Further, Na content to silica is 15 ppm. By use of TEAOH, colloidal silica whose content of metal ion is small can be obtained.

### Preparation Example 4

520 g of JIS 3 sodium silicate (SiO₂: 28.8 weight %, Na₂O: 9.7 weight %, H₂O: 61.5 weight %) is added to 2810 g of deionized water, mixed homogeneously and diluted sodium silicate of silica concentration 4.5 weight % is prepared. This diluted sodium silicate is passed through a column containing 1200 mL of H type strong acidic cation exchange resin (AMBERLITE IR120B, product of ORGANO CORPORATION), which is previously regenerated by hydrochloric acid and dealkalized, then 4040 g of active silicic acid characterized that silica concentration is 3.7 weight % and pH is 2.9 is obtained.

Obtained active silicic acid is characterized as Na content to silica is 80 ppm, Cu, Zn, Cr, Ca, Mg and Fe contents to silica are 360 ppb, 2600 ppb, 1800 ppb, 11100 ppb, 18000 ppb, and 28200 ppb, respectively. Then, this active silicic acid is passed through a column containing 100 ml of H type chelate resin (AMBERLITE IRC748, product of ORGANO CORPORATION), which is previously regenerated by hydrochloric acid and dealkalized, then 4950 g of active silicic acid characterized that silica concentration is 3.0 weight % and pH is 3.2 is obtained. This active silicic acid is characterized as Cu, Zn, Cr, Ca, Mg, and Fe contents to silica are 90 ppb, 780 ppb, 600 ppb, 6900 ppb, 9800 ppb, and 12600 ppb, respectively. Reduction of amount of metal ions by chelate resin is confirmed.

Then, colloidal particles are grown up by a build up method. That is, to 500 g of said obtained active silicic acid, 48 weight % choline hydroxide aqueous solution is added by stirring and pH is adjusted to 9, heated to 95° C. and preserved for 1 hour, then remaining 4540 g of active silicic acid is added by 6 hours. During adding process, 20 weight % TEAOH aqueous solution is added so as to maintain pH to 10, and heating is continued, and is matured at 95° C. for 1 hour, then is cooled down. After that, pressure filtration by pump circulation using hollow fiber ultrafilter membrane is carried and concentrated to silica concentration 30 weight % and approximately 490 g of colloidal silica is recovered. Particle size measured by BET method of this colloidal silica is 11.2 nm, and according to a transmission electron microscope (TEM) observation, it is understood that the colloidal silica forms non spherical hetero particles cluster, wherein short axis is approximately 12 nm and ratio of long axis/short axis is 1.5 to 8.

After 340 g of deionized water is added to obtained colloidal silica and stirred, ultrafiltration same as to afore mentioned is carried out, then Na component is washed out by concentrating to silica concentration 30 weight %. Since TEAOH is also washed out with Na component, total content of this colloidal silica is 0.65 weight % and liquid phase TEAOH is 0.17 weight %. Therefore, TEAOH fixed to silica is calculated as 0.48 weight %. Molar ratio of fixed TEAOH/silica is 0.0065.

Na content to silica is 10 ppm, and Cu, Zn, Cr, Ca, Mg, and Fe contents to silica are 50 ppb, 400 ppb, 400 ppb, 3500 ppb, 5000 ppb and 8000 ppb, respectively. By contact with chelate resin and use of TEAOH, colloidal silica whose content of metal ion is small can be obtained.

### Preparation Example 5

520 g of JIS 3 sodium silicate (SiO₂: 28.8 weight %, Na₂O: 9.7 weight %, H₂O: 61.5 weight %) is added to 2810 g of deionized water, mixed homogeneously and diluted sodium silicate of silica concentration 4.5 weight % is prepared. This diluted sodium silicate is passed through a column containing 1200 mL of H type strong acidic cation exchange resin (AMBERLITE IR120B, product of ORGANO CORPORATION), which is previously regenerated by hydrochloric acid and dealkalized, then 4040 g of active silicic acid characterized that silica concentration is 3.7 weight % and pH is 2.9 is obtained.

Then, colloidal particles are grown up by a build up method using spherical particles as a seed sol. That is, 420 g of spherical colloidal silica on the market (“SILICADOL 40L” product of Nippon Chemical Industrial Co., Ltd.: particle size by BET method; 21 nm, silica concentration; 40 weight %, Na content; 4000 ppm) is diluted by deionized water and brought to 4200 g. Then, this diluted colloidal silica is passed through a column containing 1200 mL of H type strong acidic cation exchange resin (AMBERLITE IR120B, product of ORGANO CORPORATION), which is previously regenerated by hydrochloric acid and dealkalized, and acidic colloidal silica is obtained. After that, equimolar mixture of TEAOH aqueous solution and TMAOH aqueous solution prepared by mixing these solutions by 1 to 1 ratio is added to this acidic colloidal silica and pH is adjusted to 10, heated to 90° C. to boiling point and preserved for 1 hour, then, 4040 g of above mentioned active silicic acid is added by 5 hours. During adding process, said equimolar mixture is added so as to maintain pH to 10, and heating (900C to boiling point) is continued. After adding process is over, heating (90° C. to boiling point) is continued too, and is matured, then is cooled down. After that, pressure filtration by pump circulation using hollow fiber ultrafilter membrane is carried and concentrated to silica concentration 33 weight % and approximately 950 g of colloidal silica is recovered. Particle size measured by BET method of this colloidal silica is 25 nm, and according to a transmission electron microscope (TEM) observation, it is understood that the colloidal silica forms spherical particles cluster. Since total content of TEAOH is 0.32 weight % and liquid phase TEAOH is 0.19 weight %, TEAOH fixed on silica is calculated as 0.07 weight %. Molar ratio of fixed TEAOH/silica is 0.00086.

Compositions and properties of colloidal silica shown in Preparation Examples are summarized in Tables 1 and 2.

TABLE 1

| | Preparation | Preparation | Preparation | Preparation |
|---|---|---|---|---|
| Items | Example 1 | Example 2 | Example 3 | Example 4 |
| conc. of | 20.0 | 20.0 | 30.0 | 30.0 |
| silica | | | | |
| (weight %) | | | | |
| TEAOH in | 0.87 | 0.32 | 0.40 | 0.17 |
| liquid phase | | | | |
| (weight %) | | | | |
| TEAOH fixed | 0.70 | 0.57 | 0.52 | 0.48 |
| to silica | | | | |
| (weight %) | | | | |
| Fixed TEAOH/ | 0.014 | 0.012 | 0.007 | 0.0065 |
| SiO₂ (mol/mol) | | | | |
| BET particle | 10.9 | 11.5 | 13.0 | 11.2 |
| size (nm) | | | | |
| shape of | non | non | non | non |
| particle after | spherical | spherical | spherical | spherical |
| preparation | | | | |
| Na amount to | 15 | 15 | 15 | 10 |
| silica (ppm) | | | | |

TABLE 2

| Items | Preparation Example 5 |
|---|---|
| conc. of silica (weight %) | 33.0 |
| BET particle size of seed sol | 21 |
| particle shape of seed sol | spherical |
| TMAOH of liquid phase (weight %) | 0.19 |
| TMAOH fixed to silica (weight %) | 0.13 |
| TEAOH of liquid phase (weight %) | 0.31 |
| TEAOH fixed to silica (weight %) | 0.07 |
| fixed TEAOH/SiO₂ (mol/mol) | 0.00086 |
| BET particle size (nm) | 25 |
| shape of particle after preparation | spherical |

Composition and properties of colloidal silica used in Comparative Example are summarized in Table 3.

TABLE 3

| Items | A | B | C |
|---|---|---|---|
| conc. of silica | 40.0 | 30.0 | 30.0 |
| (weight %) | | | |
| fixed TEAOH/SiO₂ | 0.0 | 0.0 | 0.0 |
| (mol/mol) | | | |
| BET particle size (nm) | 21 | 19 | 28 |
| shape of particle after | spherical | secondary | spherical |
| preparation | | flocculation | |
| Na amount to silica | 4000 | 6000 | 4100 |
| (ppm) | | | |

Examples of surface polishing of semiconductor wafer are illustrated as follows.

### <Surface Polishing Test of Semiconductor Wafer>

Polishing compounds used in Examples and Comparative Examples are prepared by following method.

### Preparation of Polishing Compound Used in Example 1

To the colloidal silica prepared by Preparation Example 1 composed of silica particles to which TEAOH is fixed and characterized that silica concentration is 20 weight % and content of metallic ion is small, TMAOH and TMAHCO₃ amount indicated in column of Example 1 in Table 4 are added as additives for the purpose to stabilize pH, to improve polishing rate and to become a pH buffering solution, and original solution for polishing agent is prepared. This original solution for polishing agent is diluted by adding deionized water so as the SiO₂ concentration of the polishing compound to be as indicated in column of Example 1 in Table 4, and 4 kinds of polishing compounds whose silica concentration are different.

### Preparation of Polishing Compound Used in Example 2

To the colloidal silica prepared by Preparation Example 4 composed of silica particles to which TEAOH is fixed and characterized that silica concentration is 30 weight % and content of metallic ion is small, TMAOH and TMAHCO₃ amount indicated in column of Example 2 in Table 4 are added as additives for the purpose to stabilize pH, to improve polishing rate and to become a pH buffering solution, and original solution for polishing agent is prepared. This original solution for polishing agent is diluted by adding deionized water so as the SiO₂ concentration of the polishing compound to be as indicated in column of Example 2 of Table 4, and 4 kinds of polishing compounds whose silica concentration are different.

### Preparation of Polishing Compound Used in Comparative Example 1

As a Comparative Example, to a colloidal silica on the market (“SILICADOL 40L” product of Nippon Chemical Industrial Co., Ltd.) indicated in A in Table 3, TMAOH and TMAHCO₃ amount indicated in column of Comparative Example 1 in Table 5 are added as additives for the purpose to stabilize pH, to improve polishing rate and to become a pH buffering solution, and original solution for polishing agent is prepared. This original solution for polishing agent is diluted by adding deionized water so as the SiO₂ concentration of the polishing compound to be as indicated in column of Comparative Example 1 in Table 5, and 4 kinds of polishing compounds whose silica concentration are different.

### Preparation of Polishing Compound Used in Comparative Example 2

As a Comparative Example, to a colloidal silica on the market (“SILICADOL SF” product of Nippon Chemical Industrial Co., Ltd.) indicated in B in Table 3, TMAOH and TMAHCO₃ amount indicated in column of Comparative Example 2 in Table 5 are added as additives for the purpose to stabilize pH, to improve polishing rate and to become a pH buffering solution, and original solution for polishing agent is prepared. This original solution for polishing agent is diluted by adding deionized water so as the SiO₂ concentration of the polishing compound to be as indicated in column of Comparative Example 2 in Table 5, and 4 kinds of polishing compounds whose silica concentration are different.

By using polishing compounds prepared as above, polishing tests are carried out according to the polishing conditions mentioned below.

### Polishing Condition

Polishing machine: SH-24, product of Speedfam Co., Ltd.
Rotating speed of platen: 70 rpm
Load: 200 g/Cm²
Rotating speed of a pressure plate: 60 rpm
Polishing pad: SUBA 600, product of Nitta Haas Incorporated.
Flow rate of polishing compound: 100 mL/min.
Polishing time: 5 minutes
Workpiece: 6 inch size silicon wafer
Washing after polishing: scrub washing by ammonia water, followed by scrub washing by deionized water for 30 seconds.
   Washing after wafer polishing is carried out by scrub washing with a scrub brush, using 1 weight % ammonia aqueous solution and deionized water for 30 seconds each. Then spin drying is carried out with N₂ gas blow.

To the polished silicon wafers obtained as above, polishing rate is measured from the difference of weight of wafer which measured before and after polishing. Haze and scratches on the surface of polished wafer are measured by inspector's eye under a condensing light. These results are also summarized in Tables 4 and 5.

TABLE 4

| | | Items | | | | | | | |
|---|---|---|---|---|---|---|---|---|---|
| | | Example 1 | | | | Example 2 | | | |
| colloidal silica | | Preparation Example 1 | | | | Preparation Example 4 | | | |
| SiO₂ conc. (weight %) | | 2.0 | 3.0 | 4.0 | 4.8 | 2.0 | 3.1 | 4.2 | 5.0 |
| addi- | TMAOH | 0.10 | 0.10 | 0.10 | 0.10 | 0.08 | 0.08 | 0.08 | 0.08 |
| tives | (mol/kg - SiO₂) | | | | | | | | |
| | TMAHCO₃ | 0.12 | 0.12 | 0.12 | 0.12 | 0.09 | 0.09 | 0.09 | 0.09 |
| | (mol/kg - SiO₂) | | | | | | | | |

| | | | | | | | | |
|---|---|---|---|---|---|---|---|---|
| pH | 10.0 | 10.0 | 10.0 | 10.1 | 10.1 | 10.1 | 10.2 | 10.2 |
| polishing rate | 0.33 | 0.38 | 0.42 | 0.46 | 0.30 | 0.35 | 0.39 | 0.44 |
| (μm/min.) | | | | | | | | |
| haze and scratch on | no | no | no | no | no | no | no | no |
| polished surface | | | | | | | | |

TABLE 5

| | | Items | | | | | | | |
|---|---|---|---|---|---|---|---|---|---|
| | | Comparative Example 1 | | | | Comparative Example 2 | | | |
| colloidal silica | | A | | | | C | | | |
| SiO₂ conc. (weight %) | | 2.0 | 3.0 | 4.2 | 5.0 | 1.8 | 2.9 | 4.0 | 5.0 |
| addi- | TMAOH | 0.10 | 0.10 | 0.10 | 0.10 | 0.08 | 0.08 | 0.08 | 0.08 |
| tives | (mol/kg - SiO₂) | | | | | | | | |
| | TMAHCO₃ | 0.12 | 0.12 | 0.12 | 0.12 | 0.09 | 0.09 | 0.09 | 0.09 |
| | (mol/kg - SiO₂) | | | | | | | | |
| pH | | 10.0 | 10.0 | 10.1 | 10.1 | 10.2 | 10.2 | 10.2 | 10.3 |

| | | | | | | | | |
|---|---|---|---|---|---|---|---|---|
| polishing rate | 0.23 | 0.30 | 0.40 | 0.45 | 0.20 | 0.30 | 0.38 | 0.46 |
| (μm/min.) | | | | | | | | |
| haze and scratch on | no | no | no | no | no | no | no | no |
| polished surface | | | | | | | | |

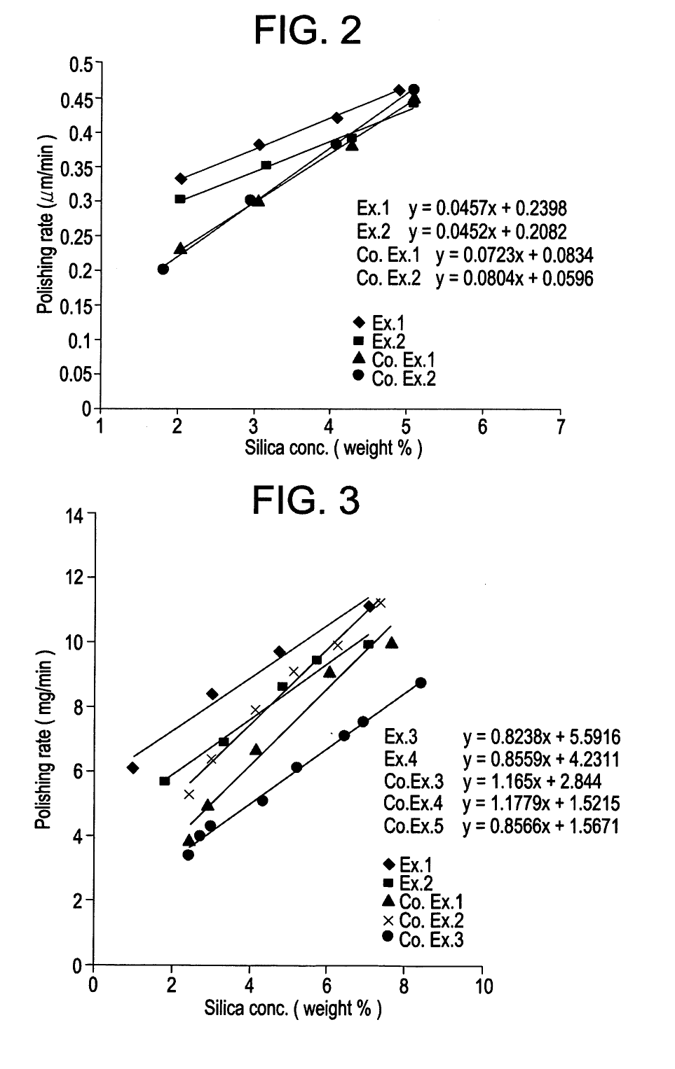

From the test results mentioned in Tables 4 and 5, it becomes clear that both Examples and Comparative Examples show good evaluation results on haze and scratch, and can obtain good polished surface. Further, polishing compounds prepared in Examples 1 and 2 and in Comparative Examples 1 and 2 are used in polishing tests, and relationship between silica concentration and obtained polishing rate are shown in FIG. 2.

From the results shown in FIG. 2, it becomes clear that grade of line of Examples 1 and 2 is smaller compared with that of Comparative Examples, that is, variation of polishing rate against concentration change of Examples is smaller than that of Comparative Examples. And in the range of lower silica concentration, polishing rate is apparently higher than that of Comparative Examples, that is, the polishing compound of Examples is confirmed that it displays excellent power at lower concentration range.

Examples regarding edge polishing of semiconductor wafer are illustrated as follows.

### <Edge Polishing Test of Semiconductor Wafer>

Polishing compounds used in Examples and Comparative Examples are prepared by following method.

### Preparation of Polishing Compound of Example 3

To the colloidal silica prepared by Preparation Example 2 composed of silica particles to which TEAOH is fixed and characterized that silica concentration is 20 weight % and content of metallic ion is small, TMAOH and TMAHCO₃ of amount indicated in column of Example 3 in Table 6 are added as additives for the purpose to stabilize pH, to improve polishing rate and to become a pH buffering solution, and original solution for polishing agent is prepared. This original solution for polishing agent is diluted by adding deionized water so as the SiO₂ concentration of the polishing compound to be as indicated in column of Example 3 in Table 6, and 4 kinds of polishing compounds whose silica concentration are different.

### Preparation of Polishing Compound of Example 4

To the colloidal silica prepared by Preparation Example 5 composed of silica particles to which TEAOH is fixed and characterized that silica concentration is 30 weight % and content of metallic ion is small, TMAOH and TMAHCO₃ of amount indicated in column of Example 4 in Table 7 are added as additives for the purpose to stabilize pH, to improve polishing rate and to become a pH buffering solution, and original solution for polishing agent is prepared. This original solution for polishing agent is diluted by adding deionized water so as the SiO₂ concentration of the polishing compound to be as indicated in column of Example 4 in Table 7, and 4 kinds of polishing compounds whose silica concentration are different.

### Preparation of Polishing Compound of Comparative Example 3

As a Comparative Example, to a colloidal silica on the market (“SILICADOL 30G30” product of Nippon Chemical Industrial Co., Ltd.) indicated in C of Table 3, TMAOH and TMAHCO₃ of amount indicated in column of Comparative Example 3 in Table 8 are added as additives for the purpose to stabilize pH, to improve polishing rate and to become a pH buffering solution, and original solution for polishing agent is prepared. This original solution for polishing agent is diluted by adding deionized water so as the SiO₂ concentration of the polishing compound to be as indicated in column of Comparative Example 3 in Table 8, and 5 kinds of polishing compounds whose silica concentration are different.

### Preparation of Polishing Compound of Comparative Example 4

As a Comparative Example, to a colloidal silica on the market (“SILICADOL SF” product of Nippon Chemical Industrial Co., Ltd.) indicated in B of Table 3, TMAOH and TMAHCO₃ of amount indicated in column of Comparative Example 4 in Table 9 are added as additives for the purpose to stabilize pH, to improve polishing rate and to become a pH buffering solution, and original solution for polishing agent is prepared. This original solution for polishing agent is diluted by adding deionized water so as the SiO₂ concentration of the polishing compound to be as indicated in column of Comparative Example 4 in Table 9, and 6 kinds of polishing compounds whose silica concentration are different.

### Preparation of Polishing Compound of Comparative Example 5

As a Comparative Example, to a colloidal silica on the market (“SILICADOL 40L” product of Nippon Chemical Industrial Co., Ltd.) indicated in A of Table 3, TMAOH and TMAHCO₃ of amount indicated in column of Comparative Example 5 in Table 10 are added as additives for the purpose to stabilize pH, to improve polishing rate and to become a pH buffering solution, and original solution for polishing agent is prepared. This original solution for polishing agent is diluted by adding deionized water so as the SiO₂ concentration of the polishing compound to be as indicated in column of Comparative Example 5 in Table 10, and 6 kinds of polishing compounds whose silica concentration are different.

By using polishing compounds prepared as above, polishing tests are carried out according to the polishing conditions mentioned below.

### Polishing Condition

Polishing machine: EP-200XW edge polishing machine, product of Speedfam Co., Ltd.
Rotating speed of wafer: 2000 rpm
Polishing time: 60 sec./piece
Flow rate of polishing compound: 3 L/min.
Polishing pad: SUBA 400
Load: 40 N/unit
Workpiece: 8 inch size silicon wafer
Washing after polishing: washing by 1 weight % ammonia water for 30 seconds, then washing by deionized water for 30 seconds.

Washing after wafer polishing is carried out by scrub washing with a scrub brush, using 1 weight % ammonia aqueous solution and deionized water for 30 seconds each. Then spin drying is carried out with N₂ gas blow.

To the polished silicon wafers obtained as above, polishing rate is measured from the difference of weight of wafer which measured before and after polishing. Haze and scratches on the surface of polished wafer are measured by inspector's eye under a condensing light. Inspection of polishing residue caused by imperfect edge polishing is carried out to whole periphery of workpiece by optical microscope observation under 800 magnifications. These results are also summarized in Tables 6 to 10.

TABLE 6

| | |
|---|---|
| | Example 3 |
| colloidal silica | Preparation Example 2 |

| | | | | |
|---|---|---|---|---|
| SiO₂ conc. (weight %) | 1.0 | 3.0 | 4.7 | 7.0 |
| TMAOH (mol/kg - SiO₂) | 0.10 | 0.10 | 0.10 | 0.10 |
| TMAHCO₃ (mol/kg - SiO₂) | 0.11 | 0.11 | 0.11 | 0.11 |
| pH | 10.1 | 10.1 | 10.2 | 10.3 |
| polishing rate (mg/min.) | 6.1 | 8.4 | 9.7 | 11.1 |
| polishing residue on periphery | no | no | no | no |
| haze and stain on attracted | no | no | no | no |
| surface | | | | |

TABLE 7

| | Example 4 | | | | |
|---|---|---|---|---|---|
| colloidal silica | Preparation Example 5 | | | | |
| SiO₂ conc. (weight %) | 1.8 | 3.3 | 4.8 | 5.7 | 7.0 |
| TMAOH (mol/kg - SiO₂) | 0.08 | 0.08 | 0.08 | 0.08 | 0.08 |
| TMAHCO₃ (mol/kg - SiO₂) | 0.09 | 0.09 | 0.09 | 0.09 | 0.09 |
| pH | 10.0 | 10.1 | 10.1 | 10.2 | 10.2 |
| polishing rate (mg/min.) | 5.7 | 6.9 | 8.6 | 9.4 | 9.9 |
| polishing residue on periphery | no | no | no | no | no |
| haze and stain on attracted | no | no | no | no | no |
| surface | | | | | |

TABLE 8

| | Comparative Example 3 | | | | |
|---|---|---|---|---|---|
| colloidal silica | A | | | | |
| SiO₂ conc. (weight %) | 2.4 | 2.9 | 4.1 | 6.0 | 7.6 |
| TMAOH (mol/kg - SiO₂) | 0.10 | 0.10 | 0.10 | 0.10 | 0.10 |
| TMAHCO₃ (mol/kg - SiO₂) | 0.11 | 0.11 | 0.11 | 0.11 | 0.11 |
| pH | 10.1 | 10.1 | 10.2 | 10.3 | 10.3 |
| polishing rate (mg/min.) | 3.9 | 5.0 | 6.7 | 9.1 | 10.0 |
| polishing residue on periphery | no | no | no | no | no |
| haze and stain on attracted | no | no | no | no | no |
| surface | | | | | |

TABLE 9

| | Comparative Example 4 | | | | | |
|---|---|---|---|---|---|---|
| colloidal silica | C | | | | | |
| SiO₂ conc. (weight %) | 2.4 | 3 | 4.1 | 5.1 | 6.2 | 7.3 |
| TMAOH (mol/kg - SiO₂) | 0.08 | 0.08 | 0.08 | 0.08 | 0.08 | 0.08 |
| TMAHCO₃ (mol/kg - SiO₂) | 0.09 | 0.09 | 0.09 | 0.09 | 0.09 | 0.09 |
| pH | 10.0 | 10.1 | 10.1 | 10.2 | 10.2 | 10.2 |
| polishing rate (mg/min.) | 5.7 | 6.4 | 7.9 | 9.1 | 9.9 | 11.2 |
| polishing residue on periphery | no | no | no | no | no | no |
| haze and stain on attracted | no | no | no | no | no | no |
| surface | | | | | | |

TABLE 10

| | Comparative Example 5 | | | | | | | |
|---|---|---|---|---|---|---|---|---|
| colloidal silica | B | B | B | B | B | B | B | B |
| SiO₂ conc. (weight %) | 2.4 | 2.7 | 3.0 | 4.3 | 5.2 | 6.4 | 6.9 | 8.4 |
| TMAOH (mol/kg - SiO₂) | 0.10 | 0.10 | 0.10 | 0.10 | 0.10 | 0.10 | 0.10 | 0.10 |
| TMAHCO₃ (mol/kg - SiO₂) | 0.11 | 0.11 | 0.11 | 0.11 | 0.11 | 0.11 | 0.11 | 0.11 |
| pH | 10.2 | 10.2 | 10.2 | 10.3 | 10.4 | 10.4 | 10.5 | 10.5 |
| polishing rate (mg/min.) | 3.4 | 4.0 | 4.3 | 5.1 | 6.1 | 7.1 | 7.5 | 8.7 |
| polishing residue on periphery | no | no | no | no | no | no | no | no |
| haze and stain on attracted | no | no | no | no | no | no | no | no |
| surface | | | | | | | | |

From the test results mentioned in Tables 6 to 10, it becomes clear that both Examples and Comparative Examples show good evaluation results on haze and stain on attracted surface of wafer. Further, polishing compounds prepared in Examples 1 and 2 and in Comparative Examples 1 and 2 are used in edge polishing tests, and relationship between silica concentration and obtained polishing rate are shown in FIG. 3.

From the results shown in FIG. 3, it becomes clear that grade of line of Examples 3 and 4 is smaller compared with that of Comparative Examples 3 and 4, that is, variation of polishing rate against concentration change of Examples is smaller than that of Comparative Examples. And in the range of lower silica concentration, polishing rate is apparently higher than that of Comparative Examples, that is, the polishing compound of Examples is confirmed that it displays excellent power at lower concentration range.

By the present invention, a polishing compound that can polish the surface or edge part of semiconductor wafer such as silicon wafer, semiconductor device substrate on the surface of which a layer of metal films or other films is formed is provided. Silica particles used in the polishing compound for semiconductor wafer of the present invention displays good washing ability in surface polishing, further in edge polishing, the compound displays higher polishing rate and better washing ability when compared with conventional polishing compound, caused by specific features and by the fact that the contents of alkali metal is very small. By use of the polishing compound for semiconductor wafer of the present invention, the quality of the wafer is not deteriorated at the surface polishing of semiconductor wafer.

### INDUSTRIAL APPLICABILITY

The polishing compound for semiconductor wafer using colloidal silica of the present invention is remarkable superior in polishing rate compared with the colloidal silica containing quaternary ammonium hydroxide only in liquid phase, where influence of polishing rate to change of concentration is small, and can accomplish good mirror polishing without causing scratches. Furthermore, since the content of alkali metal is small, bad influence to a semiconductor wafer such as remaining of abrasives after polishing can be reduced.

What is claim:

1. A polishing compound for semiconductor wafer comprising, colloidal silica composed of silica particles to which tetraethylammonium is fixed and concentration of said silica particles dispersed in water is between 0.5 to 50 weight %.

2. The polishing compound for semiconductor wafer of claim 1, wherein the silica particles to which tetraethylammonium is fixed is silica particles inside of which tetraethylammonium is fixed.

3. The polishing compound for semiconductor wafer of claim 1, wherein the silica particles to which tetraethylammonium is fixed is silica particles on the surface of which tetraethylammonium is fixed by coating a film mainly composed of silica containing tetraethylammonium.

4. The polishing compound for semiconductor wafer of claim 1, wherein concentration of tetraethylammonium contained in silica particle to which tetraethylammonium is fixed is in the range of from 5×10⁻⁴ to 2.5×10⁻² as indicated by molar ratio of tetraethylammonium/silica.

5. The polishing compound for semiconductor wafer of claim 1 comprising, containing a buffer solution prepared by combination of weak acid and strong base whose logarithms of reciprocal number of acid dissociation constant (pKa) at 25° C. is between 8.0 to 12.5, and said the polishing compound for semiconductor wafer displays buffering action between pH 8 toll.

6. The polishing compound for semiconductor wafer of claim 5, wherein an anion composing the weak acid is at least the one selected from the group consisting of carbonate ion and hydrogencarbonate ion, and a cation composing the strong base is at least the one selected from the group consisting of choline ion, tetramethylammonium ion and tetraethylammonium ion.

7. The polishing compound for semiconductor wafer of claim 1, comprising a mixture of the silica particles to which tetraethylammonium is fixed and spherical silica particles to which tetraethylammonium is not fixed, wherein concentration of the particles to which tetraethylammonium is fixed is from 0.5 to 10 weight % and total concentration of silica particles is from 0.5 to 50 weight %.

8. The polishing compound for semiconductor wafer of claim 1, wherein the content of alkali metal to silica in said polishing compound for semiconductor wafer is less than 50 ppm.

9. The polishing compound for semiconductor wafer of claim 2, wherein the silica particles to which tetraethylammonium is fixed contains colloidal silica having average short axis of 5 to 30 nm measured by a transmission electric microscope and forming non spherical hetero particles cluster whose ratio of long axis/short axis is from 1.5 to 15.

10. The polishing compound for semiconductor wafer of claim 3, wherein the silica particles to which tetraethylammonium is fixed contains colloidal silica whose average particle size is 15 to 50 nm and is forming spherical particles cluster.
